(19) United States
(12) Patent Application Publication
(10) Pub. No.: US 2024/0200692 A1
(43) Pub. Date: Jun. 20, 2024

(54) MULTILAYER PIPELINE

(71) Applicant: TI Automotive (Fuldabrueck) GmbH, Fuldabrueck (DE)

(72) Inventors: Andre HÄCKEL, Waldock (DE); Frank FAHRENHOLZ, Kassel (DE); Martin SCHRAMOWSKI, Kassel (DE); Siegfried ARNOLD, Kassel (DE)

(21) Appl. No.: 18/287,840

(22) PCT Filed: Apr. 21, 2022
(86) PCT No.: PCT/IB2022/053752

§ 371 Date: Oct. 20, 2023

(30) Foreign Application Priority Data
Apr. 21, 2021 (EP) 21169635.6

(51) Int. Cl. F16L 11/04; B32B 1/08; B32B 7/02; B32B 27/08; B32B 27/30; B32B 27/32; B32B 27/34

(52) U.S. Cl. CPC F16L 11/045; B32B 1/08; B32B 7/02; B32B 27/08; B32B 27/306; B32B 27/322; B32B 27/34; B32B 2250/05; B32B 2250/24; B32B 2307/202; B32B 2307/7376; B32B 2597/00

(57) ABSTRACT

A multilayer motor vehicle pipeline, wherein at least one barrier layer comprised of at least one material from the group “butene diol-vinyl alcohol copolymer (BVOH), polyvinyl alcohol (PVOH), polymer blend with BVOH, polymer blend with PVOH” is provided. At least one outer layer made of plastic is arranged on the exterior side of the barrier layer.

### RELATED APPLICATIONS

The present disclosure is a § 371 of international PCT Application No. PCT/IB2022/053752, filed Apr. 21, 2022, which claims priority to European Application 21169635.6, filed on Apr. 21, 2021, the entire contents of each of which are incorporated herein by reference in their entirety.

### FIELD

The disclosure relates to a multilayer motor vehicle pipeline with at least one barrier layer and an outer layer arranged on the exterior side of the barrier layer. In an especially preferred embodiment of the disclosure, the multilayer motor vehicle pipeline according to the disclosure is a hydrogen transport line or a motor vehicle pipeline for transporting hydrogen.

### BACKGROUND

Hydrogen is becoming increasingly important in the automotive industry for the supply of fuel cells in motor vehicles. To this extent, motor vehicle pipelines or tubes for transporting the hydrogen are also already known. In this conjunction, hydrogen is characterized by the disadvantage that it shows a relatively high permeation tendency relative to the pipe walls of such a pipeline. Efforts are thus underway to design the motor vehicle pipelines in such a way that they have a high barrier effect with regard to the permeation of hydrogen. To this end, polyamides with a high crystallinity have already been used as materials for the tube or pipe walls. In order to increase the mechanical resistance and resistance to permeation, use is further also made of relatively thick-walled pipelines. However, these are disadvantageous in view of the required material outlay and in view of the corresponding weight of the pipelines. Improvement is needed in this regard.

### SUMMARY

The disclosure is based on the technical problem of indicating a multilayer motor vehicle pipeline of the kind mentioned at the outset, which has a high barrier effect against the fluid media to be passed through, and which is characterized in particular by a slight permeation of hydrogen through the pipeline walls, and further constructed with relatively little outlay and with comparatively slight wall thicknesses.

In order to resolve this technical problem, the disclosure teaches a multilayer motor vehicle pipeline or tube, wherein at least one barrier layer comprised of at least one material from the group “butene diol-vinyl alcohol copolymer (BVOH), polyvinyl alcohol (PVOH), polymer blend with BVOH, polymer blend with PVOH” is provided, and wherein at least one outer layer made of plastic is arranged on the exterior side of the barrier layer. It lies within the framework of the disclosure that this motor vehicle pipeline be a hydrogen transport pipeline for motor vehicles. Butene diol vinyl alcohol (BVOH) and/or a polymer blend with BVOH is especially preferred for the barrier layer according to the disclosure. In particular in terms of its barrier effect against hydrogen, this material has proven itself especially well. It further lies within the framework of the disclosure that at least one inner layer made of plastic be arranged on the interior side of the barrier layer.

The disclosure is based upon the discovery that the design of the motor vehicle pipeline or tube according to the disclosure has a high barrier effect relative to fluid media passed through the pipeline, and is distinguished above all by a surprisingly slight permeation relative to hydrogen that has been passed through. Nevertheless, the motor vehicle pipeline according to the disclosure can be given a relatively low-cost design, and can in particular be formed with a comparatively slight pipe wall thickness by comparison to the pipelines known to date in this conjunction. In addition, the motor vehicle pipeline is characterized by a high mechanical resistance, and in particular by an outstanding resistance in relation to high pressures. Furthermore, the temperature stability of the pipeline according to the disclosure must be highlighted as very advantageous. Within the framework of the disclosure, there are various options for specifically designing the pipeline according to the disclosure.

Within the framework of the disclosure, providing a barrier layer according to the disclosure comprised of BVOH and/or PVOH means that the barrier layer consists of at least 85 wt %, preferably of at least 90 wt %, and preferentially of at least 95 wt % of BVOH and/or PVOH, and especially preferably of BVOH. A very especially preferred embodiment of the disclosure is characterized in that the barrier layer consists of at least 98 wt % of BVOH and/or PVOH, and very especially preferably of BVOH.

Within the framework of the disclosure, when a barrier layer according to the disclosure consists of a polymer blend with BVOH or a polymer blend with PVOH, it means in particular that this polymer blend consists of at least 50 wt %, and preferably of at least 55 wt % of BVOH or PVOH. It lies within the framework of the disclosure that polymer blends of BVOH with EVOH (ethylene-vinyl alcohol copolymer) or PVOH with EVOH are used. EVOH can basically also be used as the material for the barrier layer according to the disclosure.

According to the disclosure, at least one outer layer of plastic is provided on the exterior side of the barrier layer. It is recommended that the outer layer consist of a plastic or essentially of a plastic from the group “polyamide, polyolefin”. It is best that the outer layer consists of at least 95 wt % of a plastic from the group “polyamide, polyolefin”. A very preferred embodiment of the disclosure is characterized in that the outer layer consists or essentially consists of polyamide. In this conjunction, a very proven embodiment is characterized in that the outer layer consists or essentially consists of polyamide 12 and/or polyamide 612.

If it is stated here and below that a layer consists or essentially consists of polyolefin, this means in particular that the layer consists or essentially consists of polypropylene and/or polyethylene and preferably HDPE. If a layer consists of polyamide or essentially consists of polyamide within the framework of the disclosure, a semi-aromatic polyamide can also be involved.

It lies within the framework of the disclosure that at least one, and preferably one, first bonding layer made of plastic is arranged between the barrier layer and the outer layer. According to a recommended embodiment of the disclosure, this first bonding layer is directly connected to the interior side of the outer layer made of plastic, without additional layers being interspersed. The first bonding layer made of plastic is best directly connected to the exterior side of the barrier layer, without additional layers being interspersed. However, it is also possible that at least one additional layer—in particular made of plastic—be interspersed between the first bonding layer and the outer layer and/or between the first bonding layer and the barrier layer. An especially proven embodiment of the disclosure is characterized in that the first bonding layer consist of a polyamide or essentially of a polyamide. The first bonding layer preferably consists of at least 90 wt % of the polyamide. For example, polyamide 6 can be used as the polyamide for the first bonding layer.

It lies within the framework of the disclosure that at least one inner layer made of plastic is arranged on the interior side of the barrier layer. An especially preferred embodiment of the disclosure is characterized in that the inner layer consists of a plastic or essentially consists of a plastic from the group “polyamide, polyolefin, fluoropolymer”. The inner layer best consists of at least 95 wt % of at least one of the mentioned plastics. Within the framework of the disclosure, it has proven effective that at least areas of the inner layer have an electrically conductive design. According to an especially recommended embodiment of the disclosure, the inner layer consists of a polyamide or essentially of a polyamide. It is recommended that the inner layer consist or essentially consist of at least one polyamide from the group “polyamide 6, polyamide 12, polyamide 612”.

A preferred embodiment of the disclosure is characterized in that at least one, and preferably one second, bonding layer made of plastic is arranged between the barrier layer and inner layer. This second bonding layer preferably consists of a polyamide or essentially of a polyamide. For example, the second bonding layer can consist or essentially consist of polyamide 6. Within the framework of the disclosure, it has proven effective for the second bonding layer to be directly connected to the interior side of the barrier layer, without additional layers being interspersed. The second bonding layer is best directly connected to the exterior side of the inner layer, without additional layers being interspersed. However, additional layers—in particular made of plastic—can basically also be arranged between the inner layer and second bonding layer, or between the second bonding layer and barrier layer.

It lies within the framework of the disclosure that at least one—in particular one—innermost layer made of plastic adjoining the interior side of the inner layer is provided. According to a very proven embodiment of the disclosure, the innermost layer consists of a fluoropolymer or essentially of a fluoropolymer. Especially preferred within the framework of the disclosure is an embodiment in which an innermost layer is provided that consists of ETFE or essentially consists of ETFE. ETFE is an ethylene-tetrafluoroethylene copolymer. It further lies within the framework of the disclosure that at least areas of the innermost layer have an electrically conductive design.

According to a recommended embodiment of the disclosure, the innermost layer is directly connected to the interior side of the inner layer, without additional layers being interspersed. However, at least one additional layer—in particular made of plastic—could here also be interspersed.

A recommended embodiment of the disclosure is characterized in that the thickness of the barrier layer measures at least 5%, preferably at least 10%, of the overall wall thickness of the pipeline. The thickness of the outer layer best measures at least 10%, in particular at least 15%, of the overall wall thickness of the pipeline. The thickness of the inner layer preferably measures at least 5%, preferably at least 10%, of the overall wall thickness of the pipeline. In an embodiment of the disclosure, the thickness of the barrier layer measures at least 15%, the thickness of the outer layer at least 20%, and the thickness of the inner layer at least 15% of the overall wall thickness of the pipeline. Another embodiment of the disclosure is characterized in that the thickness of the outer layer measures at least 25%, the thickness of the barrier layer at least 20%, and the thickness of the inner layer at least 20% of the overall wall thickness of the pipeline. The overall wall thickness of the pipeline measures in particular 0.7 to 2.5 mm, preferably 0.8 to 2 mm, and especially preferably 0.8 to 1.8 mm.

The multilayer motor vehicle pipeline according to the disclosure is characterized by a surprisingly high barrier effect relative to fluid media passed through the pipeline. Above all, the motor vehicle pipeline is characterized by a high barrier effect relative to hydrogen that is passed through the pipeline. In particular the barrier layer designed according to the disclosure contributes to this. However, it must also be emphasized that the motor vehicle pipeline according to the disclosure has an advantageously high mechanical resistance, and above all has a high resistance relative to high internal pressures. Furthermore, the motor vehicle pipeline according to the disclosure is characterized by a high temperature resistance. Nonetheless, the pipeline according to the disclosure is comparably inexpensive to manufacture.

### BRIEF DESCRIPTION OF THE DRAWINGS

The disclosure will be described in more detail below based upon a drawing that only represents an exemplary embodiment. Schematically shown on:

FIG. 1 is a perspective view of a pipeline according to the disclosure;

FIG. 2 is a section through the object according to FIG. 1; and

FIG. 3 is the object according to FIG. 2 in another embodiment.

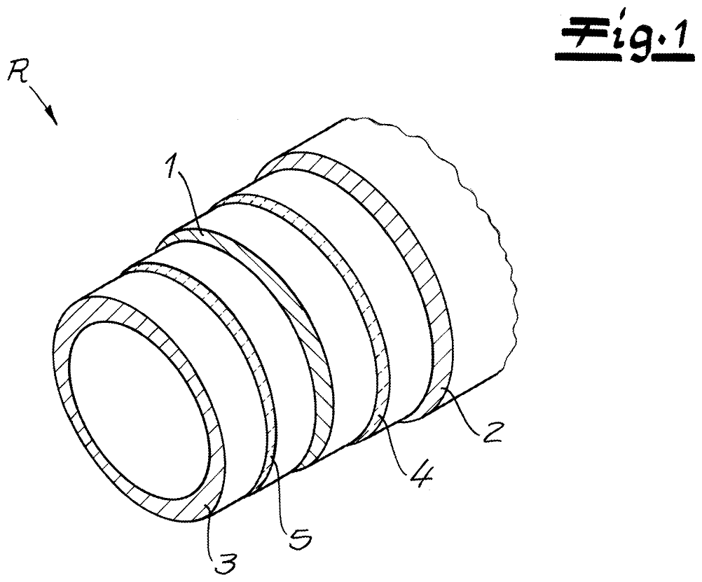

### DETAILED DESCRIPTION

The figures show a multilayer motor vehicle tube or pipeline R according to the disclosure with a barrier layer 1. This motor vehicle pipeline R is a hydrogen transport pipeline for passing hydrogen through. In the exemplary embodiment, the barrier layer 1 consists of butene diol-vinyl alcohol copolymer (BVOH) or essentially of BVOH. In the exemplary embodiment according to the figures, an outer layer 2 made of polyamide 12 is arranged on the exterior side of the barrier layer 1. In addition, the pipeline R in the exemplary embodiment has an inner layer 3, for example which consists or essentially consists of polyamide 6. The inner layer 3 can be provided with conductivity additives, so that the inner layer 3 is electrically conductive in design, at least on its interior side.

In the exemplary embodiment according to the figures, a first bonding layer 4 is arranged between the outer layer 2 and the barrier layer 1, for example which can consist of polyamide 6 or essentially consist of polyamide 6. In the exemplary embodiment according to the disclosure, a second bonding layer 5 is interspersed between the inner layer 3 and the barrier layer 1, for example which can consist of polyamide 6 or essentially consist of polyamide 6.

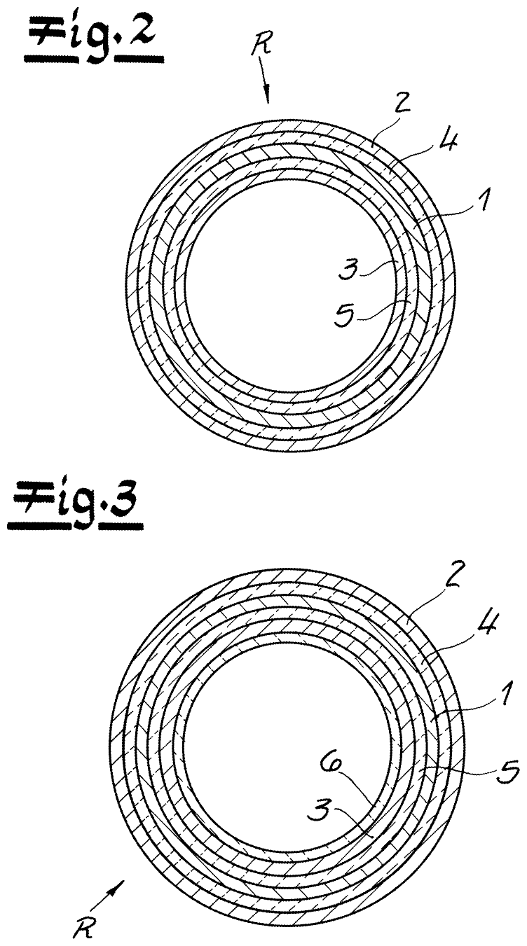

In the embodiment on FIG. 2, the motor vehicle pipeline R according to the disclosure has a total of five layers, specifically, from the outside in, the outer layer 2, the first bonding layer 4, the barrier layer 1 made of BVOH, the second bonding layer 5 and the inner layer 3.

In the exemplary embodiment on FIG. 3, a total of six layers of the pipeline are provided. In comparison to the embodiment according to FIG. 2, an additional innermost layer 6 is present here. This innermost layer 6 preferably consists of a fluoropolymer or essentially of a fluoropolymer, and in the exemplary embodiment according to FIG. 3, best consists of ETFE or essentially of ETFE. The innermost layer 6 can here have conductivity additives, so that the innermost layer 6 is conductive in design, at least on its interior side.

1. A multilayer motor vehicle pipeline, having at least one barrier layer comprised of at least one material selected from the group of butene diol-vinyl alcohol copolymer (BVOH), polyvinyl alcohol (PVOH), polymer blend with BVOH, polymer blend with PVOH, and wherein at least one outer layer made of plastic is arranged on the exterior side of the barrier layer.

2. The pipeline according to claim 1, wherein the motor vehicle pipeline is a hydrogen transport pipeline.

3. The pipeline according to claim 1, wherein at least one inner layer made of plastic is arranged on the interior side of the barrier layer.

4. The pipeline according to claim 1, wherein the outer layer consists essentially of a plastic selected from the group polyamide, polyolefin.

5. The pipeline according to claim 1, wherein the outer layer consists essentially of polyamide 12 and/or polyamide 612.

6. The pipeline according to claim 1, wherein at least one first bonding layer made of plastic is arranged between the barrier layer and the outer layer, wherein the first bonding layer consists of a polyamide.

7. The pipeline according to claim 1, wherein the inner layer consists essentially of a plastic selected from the group “polyamide, polyolefin, fluoropolymer”.

8. The pipeline according to claim 1, wherein at least areas of the inner layer are configured to be electrically conductive.

9. The pipeline according to claim 1, wherein the inner layer consists essentially of a polyamide selected from the group polyamide 6, polyamide 12, polyamide 612.

10. The pipeline according to claim 1, wherein at least one second bonding layer made of plastic is arranged between the barrier layer and the inner layer, wherein the second bonding layer consists of a polyamide.

11. The pipeline according to claim 1, wherein at least one innermost layer made of plastic is connected to the interior side of the inner layer, wherein the innermost layer consists essentially of a fluoropolymer.

12. The pipeline according to claim 1, wherein the innermost layer consists essentially of ETFE.

13. The pipeline according to claim 1, wherein at least areas of the innermost layer are configured to be electrically conductive.

14. The pipeline according to claim 1, wherein a thickness of the barrier layer measures at least 5% of the overall wall thickness of the pipeline.

15. The pipeline according to claim 6, wherein the first bonding layer consists essentially of polyamide 6.

16. The pipeline according to claim 10, wherein the second bonding layer consists essentially of polyamide 6.

17. The pipeline according to claim 1, wherein a thickness of the barrier layer measures at least 10% of the overall wall thickness of the pipeline.
